(19) United States
(12) Patent Application Publication
(10) Pub. No.: US 2009/0224575 A1
(43) Pub. Date: Sep. 10, 2009

(54) SUBASSEMBLY FOR A SLIDING ROOF

(76) Inventors: Joachim Roder, Muhlheim (DE); Zlatko Hogl, Darmstadt (DE); Stefan Vogel, Ortenberg (DE)

Correspondence Address: CARLSON, GASKEY & OLDS, P.C., 400 WEST MAPLE ROAD, SUITE 350, BIRMINGHAM, MI, 48009, US

(21) Appl. No.: 12/397,411

(22) Filed: Mar. 4, 2009

(30) Foreign Application Priority Data
Mar. 4, 2008 (EP) 08 004 012.4

(51) Int. Cl. B60J 7/057

(52) U.S. Cl. 296/223; 49/352

(57) ABSTRACT

A subassembly for a sliding roof includes right and left guiderails, which lie opposite each other. A component extends between the left and right guiderails and is guided therein. A cable includes a first section that extends between a right front side of the component and a left rear side of the component. The cable also includes a second section that extends between a left front side and a right rear side. Some sections of the cable are guided in a Bowden cable sheath.

### RELATED APPLICATION

This application claims priority to European Application No. 08 004 012.4, which was filed Mar. 4, 2008.

### TECHNICAL FIELD

The invention relates to a subassembly for a sliding roof, and in particular relates to a component which is guided displaceably in two mutually opposite guiderails. The component can be, for example, a sunshield roller blind or a cover.

### BACKGROUND OF THE INVENTION

One problem with a component of the type mentioned above is that it should not tilt in the guiderails. Another problem with the component is that it may not be smoothly displaced in the guiderails. This problem becomes more significant the shorter the component (as viewed in its direction of displacement). If, for example, a bow is considered, the bow, as viewed in idealized form, being mounted in a point-like manner in each guiderail, it can be seen that this type of guide does not provide any protection whatsoever against tilting.

DE 100 64 718 C1 disclosed a sunshield roller blind with a bow to which two cables are attached. The two cables are guided via a total of six deflecting pulleys such that tilting of the bow is prevented. The construction is comparatively complicated because of the large number of deflecting pulleys.

The object of the invention is to provide a subassembly for a sliding roof, in which tilting of the component guided in the guiderails is reliably prevented.

### SUMMARY OF THE INVENTION

To achieve this objective, the invention provides a subassembly for a sliding roof that includes right and left guiderails which lie opposite each other. A component extends between the left and right guiderails and is guided therein. A cable includes a first section that extends between a right front side of the component and a left rear side of the component, and includes a second section that extends between a left front side and a right rear side, some sections of the cable being guided in a Bowden cable sheath.

The use of Bowden cable sheaths for guiding the cables results in a particularly space-saving construction. Furthermore, the cables are well protected, thus preventing soiling.

If use is made in the application of terms such as “at the front”, “at the rear,” “on the right” and “on the left,” this is to facilitate good comprehension. These terms are directed to the customary arrangement of the subassembly on the roof of a motor vehicle and also toward the customary direction of travel of the vehicle. However, there is no change to the technical function if the subassembly is constructed “in a laterally reversed manner,” and therefore the components which are described in the application as “on the right” are then arranged on the left side.

According to a preferred embodiment of the invention, it is provided that the cable is designed as a single piece. This reduces the outlay on installation, since only a single cable of endless design has to be attached.

The cable is connected to the component to be displaced, at the right and left ends thereof, such that tensile forces can be transmitted. In particular, drivers that are fitted into the component are attached to the cable. Forces can thereby be transmitted to the component, and vice versa, with little outlay.

According to an embodiment of the invention, it is provided that a deflecting pulley for the cable is attached to the front end of each guiderail. This makes it possible to deflect the cable at the front end of the deflecting rail in a very narrow space without a large amount of friction being produced.

A first Bowden cable sheath extends from an abutment, which is assigned to the right deflecting pulley, to the rear where the first Bowden cable sheath extends to an abutment of the left deflecting pulley on the left guiderail. A second Bowden cable sheath extends from an abutment, which is assigned to the left deflecting pulley, to the rear where the second Bowden cable sheath extends to an abutment on the right guiderail. In this embodiment, construction space is not required for the cable in front of the guiderails.

According to an alternative embodiment, a first Bowden cable sheath extends from a front abutment on the right guiderail to the left guiderail where the first Bowden cable sheath extends to the rear to a rear abutment. A second Bowden cable sheath extends from a front abutment on the left guiderail to the right guiderail where the second Bowden cable sheath extends to the rear to a rear abutment. The advantage of this embodiment is that construction space is not required for the cable behind the guiderails.

A compression spring is arranged between an abutment and that end of the Bowden cable sheath which is assigned thereto. The required prestressing of the cable, such that the prestressing centers the component without play, can be produced by the compression spring with little outlay.

According to an embodiment of the invention, a cable sheath which is used to move the cable is provided. The cable sheave can be arranged at any location and can be used in order to couple a driving motor to the cable such that the component can be displaced by the driving motor.

The component may be a bow which is part of a sunshield roller blind. The component may alternatively also be a cover which is part of a sliding roof system.

The invention is described below with reference to two embodiments which are illustrated in the attached drawings, in which:

### BRIEF DESCRIPTION OF THE DRAWINGS

FIG. 1 shows schematically a vehicle roof with a sliding roof attached thereto;

FIG. 2 shows schematically in a top view a first embodiment of a subassembly according to the invention; and

FIG. 3 shows schematically in a top view a second embodiment of a subassembly according to the invention.

### DETAILED DESCRIPTION OF THE PREFERRED EMBODIMENT

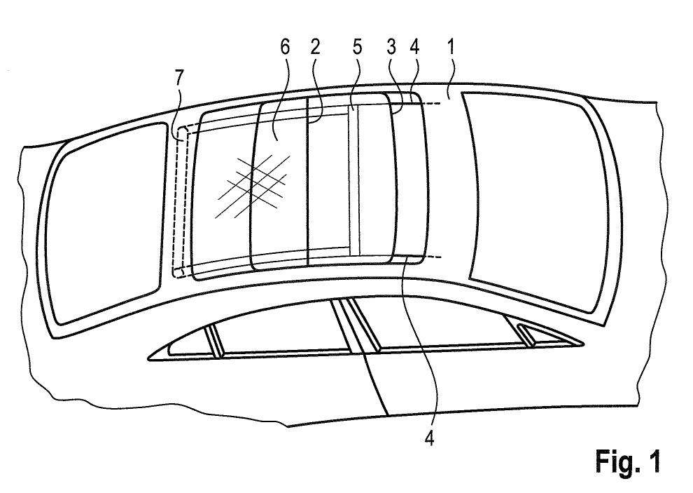

FIG. 1 shows schematically a roof 1 of a motor vehicle which is provided with a sliding roof. The sliding roof has a rear cover 2 and a front cover 3, with the front cover 3 being shown in a partially pushed-back position in which the front cover 3 overlaps with the rear cover 2. The front cover 3 serves to partially or completely open up a roof opening formed in the roof 1. A sunshield roller blind can be displaced below the cover between a pushed-back position, in which a bow 5 is located at the rear, and a pulled-forward position, in which the bow 5 is located at the front and a roller blind web 6 provides shade for the interior.

Guiderails 4 to which the cover 3 can be displaceably attached are attached to the roof 1. Component 5 which, in the exemplary embodiment shown here, is the bow 5 of the roller sunblind is guided displaceably in the guiderails 4. The roller sunblind includes the roller blind web 6 that extends between the bow 5, which is arranged at the front as seen in the direction of travel, and a winding shaft 7 arranged at the rear.

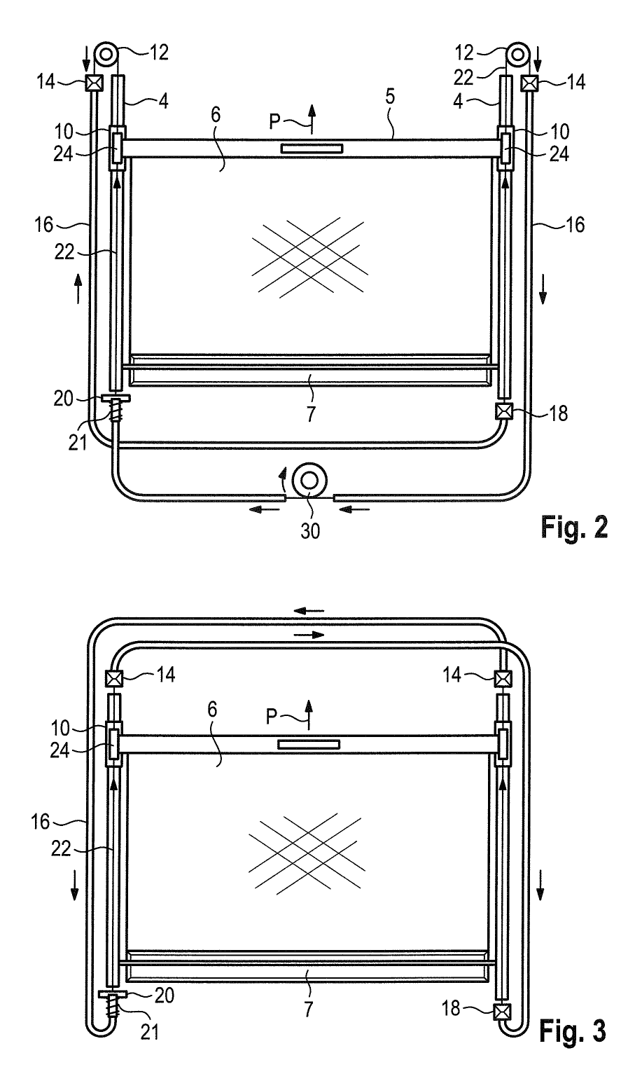

FIG. 2 shows the sunshield system in detail. The bow 5, as a component which is mounted in the two guiderails 4, is provided at each of its outer ends with a slider 10 which is guided displaceably in the guiderails 4. A deflecting pulley 12 is arranged on each side at the front end of the guiderails 4. The deflecting pulley 12 is assigned a respective abutment 14 for a Bowden cable sheath 16. An abutment for each Bowden cable sheath is likewise arranged at the rear end of each guiderail, with the abutment which is arranged at the rear end of the right guiderail 4 being provided with the reference number 18 and the abutment which is assigned to the left guiderail 4 being provided with the reference number 20. The abutment 20 is provided with a compression spring 21 which endeavors to push the Bowden cable sheath 16 away from the actual abutment.

A cable 22 which is designed as a single piece, i.e. is of endless design, is provided. The course of the cable 22 is described here starting from the right end of the bow 5. The cable 22 is provided with two drivers or fitting seals 24 of which one is fitted into a corresponding receptacle in the left slider 10 of the bow 5. The cable 22 runs from there, i.e. from the front edge of the bow 5, forward about the right deflecting pulley 12 and through the abutment 14 where the cable 22 enters the Bowden cable sheath 16 which is supported there. The cable 22 then continues to run to the rear on the right side and is deflected to the left behind the right guiderail 4 such that it finally runs through the left abutment 20 at which the corresponding Bowden cable sheath 16 ends. From the abutment 20, the cable 22 runs forward to a point where the second fitting seal 24 is fitted into the left slider 10 of the bow 5. The cable 22 runs from there forward about the left deflecting pulley 12 and through the abutment 14 where it enters the second Bowden cable sheath 16. The cable 22 runs in the second Bowden cable sheath 16 along the left guiderail 4 to the rear where the cable 22 is deflected at the end of the guiderail 4 such that the cable 22 passes to the abutment 18 on the right guiderail 4. It emerges there from the Bowden cable sheath 16 and runs forward to the slider 10 at the right end of the bow 5 on the rear side thereof. Owing to the course of the cable 22, the cable 22 prevents the bow 5 from tilting between the guiderails 4. This is based on the fact that a displacement of the cable 22 at the right end of the bow 5 leads to the displacement of the same at the left end of the bow 5. This can easily be understood with reference to an assumed displacement of the bow 5 to the front in the guiderails 4, as indicated by the arrow P. In the process, the cable 22 is carried along both on the right and the left side of the bow 5, as the arrows assigned to the cable show.

The compression spring 21, which is arranged on the abutment 20, prestresses the entire system comprising the cable 22 and Bowden cable sheaths 16 such that there is no play. The Bowden cable sheaths 16 ensure a low-friction and soiling-protected guide for the cables 22.

A cable sheath 30 is shown that can be used to couple a driving motor to the system. For this purpose, the cable 22 is looped around the cable sheath 30 in a plurality of revolutions such that a driving force can be introduced into the cable 22 by the cable friction produced. The cable sheath 30 can be arranged at any location on the cable 22 such that the driving motor can ultimately be arranged optimally with regard to the available space.

FIG. 3 shows an alternative configuration. The same reference numbers are used for the components known from the embodiment from FIG. 2. The essential difference over the embodiment from FIG. 2 is that the cable 22 from the right to the left side and from the left to the right side is not guided behind the winding shaft 7 but rather in the front region of the system. This makes it possible to arrange a driving motor, for example, in the front region of the sunshield system.

In the embodiment shown, no deflecting pulleys are used. However, in a departure therefrom, in the region of the deflection at the rear end of the guiderails 4, where the cable is deflected by 180°, use can be made of deflecting pulleys similar to those which are arranged at the front end of the guiderails 4 in the embodiment according to FIG. 2.

In the embodiments described, a bow 5 is used as the component which can be displaced in the guiderails 4. However, it can also be provided according to the invention that the component is a cover of a sliding roof system, in which it is ensured by the cable that the cover is not tilted during displacement in the guiderails.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A subassembly for a sliding roof comprising:
a right guiderail and a left guiderail which lie opposite each other;
a component which extends between the right and left guiderails and is guided therein; and
a cable having a first section that extends between a right front side of the component and a left rear side of the component, and a second section that extends between a left front side and a right rear side of the component, and wherein at least some sections of the cable are guided in a Bowden cable sheath.

2. The subassembly as claimed in claim 1, wherein the cable is designed as a single piece.

3. The subassembly as claimed in claim 1, wherein the cable is connected to the component at the right and left ends thereof such that tensile forces can be transmitted.

4. The subassembly as claimed in claim 3, wherein drivers which are fitted into the component are attached to the cable.

5. The subassembly as claimed in claim 1, wherein a deflecting pulley for the cable is attached to a front end of each guiderail.

6. The subassembly as claimed in claim 5, wherein a first Bowden cable sheath extends from an abutment, which is assigned to a right deflecting pulley, to the rear where the first Bowden cable sheath extends to an abutment on the left guiderail, and wherein a second Bowden cable sheath extends from an abutment, which is assigned to a left deflecting pulley, to the rear where the second Bowden cable sheath extends to an abutment on the right guiderail.

7. The subassembly as claimed in claim 1, wherein a first Bowden cable sheath extends from a front abutment on the right guiderail to the left guiderail where the first Bowden cable sheath extends to the rear to a rear abutment, and a second Bowden cable sheath extends from a front abutment on the left guiderail to the right guiderail where the second Bowden cable sheath extends to the rear to a rear abutment.

8. The subassembly as claimed in claim 1, wherein a compression spring is arranged between an abutment and that end of the Bowden cable sheath which is assigned thereto.

9. The subassembly as claimed in claim 1, including a cable sheave that is used to move the cable.

10. The subassembly as claimed in claim 9, wherein a driving motor is coupled to the cable sheath.

11. The subassembly as claimed in claim 1, wherein the component is a bow which is part of a sunshield roller blind.

12. The subassembly as claimed in claim 1, wherein the component is a cover which is part of a sliding roof system.
